(19) United States
(12) Patent Application Publication
(10) Pub. No.: US 2012/0129696 A1
(43) Pub. Date: May 24, 2012

(54) METHOD FOR INCREASING THE LEVEL OF FREE AMINO ACIDS IN STORAGE TISSUES OF PERENNIAL PLANTS

(75) Inventors: Harald Köhle, Bobenheim (DE); Alexander Wissemeier, Speyer (DE); Robert John Gladwin, Macclesfield (GB); Edson Begliomini, Sao Paulo (BR); Marco-Antonio Tavares-Rodrigues, Sao Paulo (BR)

(73) Assignee: BASF SE, Ludwigshafen (DE)

(21) Appl. No.: 13/387,026

(22) PCT Filed: Jul. 15, 2010
(86) PCT No.: PCT/EP2010/060246

§ 371 Date: Jan. 25, 2012

(30) Foreign Application Priority Data
Jul. 28, 2009 (EP) 09166533.1

(51) Int. Cl. A01N 55/02; A01P 21/00; A01N 43/56

(52) U.S. Cl. 504/126; 504/282

(57) ABSTRACT

The present invention relates to method for increasing the level of free amino acids in storage tissues of perennial plants comprising the application of at least one strobilurin (compound A) selected from the group consisting of pyraclostrobin, orysastrobin, azoxystrobin, dimoxystrobin, enestroburin, fluoxastrobin, kresoxim-methyl, metominostrobin, orysastrobin, picoxystrobin, pyribencarb, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-15 methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)-ethyl]benzyl)carbamate and 2-(2-(3-(2,6-dichlorophenyl)-1-methyl-allylideneaminooxymethyl)-phenyl)-2-methoxyimino-N-methyl-acetamide to the plant following the period of vegetative growth. In addition, the invention relates to the use of at least one strobilurin (compound A) selected from the group consisting of pyraclostrobin, orysastrobin, azoxystrobin, dimoxystrobin, enestroburin, fluoxastrobin, kresoxim-methyl, metominostrobin, orysastrobin, picoxystrobin, pyribencarb, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-15 methoxy-2-(2-(N-(4-methoxy-phenyl)-cyclopropane-carboximidoylsulfanyl-methyl)-phenyl)-acrylic acid methyl ester, methyl (2-chloro-5-[1-(3-methylbenzyloxyimino)-ethyl]benzyl)carbamate and 2-(2-(3-(2,6-dichlorophenyl)-1-methyl-allylideneaminooxymethyl)-phenyl)-2-methoxyimino-N-methyl-acetamide for increasing the level of free amino acids in storage tissues of perennial plants.

The present invention relates to method for increasing the level of free amino acids in storage tissues of perennial plants comprising the application of at least one strobilurin (compound A) selected from the group consisting of pyraclostrobin, orysastrobin, azoxystrobin, dimoxystrobin, enestroburin, fluoxastrobin, kresoxim-methyl, metominostrobin, orysastrobin, picoxystrobin, pyribencarb, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-15 methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)-ethyl]benzyl)carbamate and 2-(2-(3-(2,6-dichlorophenyl)-1-methyl-allylideneaminooxymethyl)-phenyl)-2-methoxyimino-N-methyl-acetamide to the plant following the period of vegetative growth.

In addition, the invention relates to the use of at least one strobilurin (compound A) selected from the group consisting of pyraclostrobin, orysastrobin, azoxystrobin, dimoxystrobin, enestroburin, fluoxastrobin, kresoxim-methyl, metominostrobin, orysastrobin, picoxystrobin, pyribencarb, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-15 methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)-ethyl]benzyl)carbamate and 2-(2-(3-(2,6-dichlorophenyl)-1-methyl-allylideneaminooxymethyl)-phenyl)-2-methoxyimino-N-methyl-acetamide for increasing the level of free amino acids in storage tissues of perennial plants.

Furthermore, the invention relates to the use of an agrochemical mixture for increasing the level of free amino acids in storage tissues of perennial plants, comprising at least one strobilurin (compound A) as defined in claim 14 and at least one further active ingredient (compound B) selected from the group consisting of

(i) carboxylic amides selected from fluopyram, boscalid, fenhexamid, metalaxyl, di-methomorph, fluopicolide (picobenzamid), zoxamide, mandipropamid, carpropamid, N-(3′,4′,5′-trifluorobiphenyl-2-yl)-3-difluoromethyl-1-methyl-1H-pyrazole-4-carboxamide, N-[2-(4′-trifluoromethylthio)-biphenyl]-3-difluoromethyl-1-methyl-1H-pyrazole-4-carboxamide, bixafen, N-[2-(1,3-dimethylbutyl)-phenyl]-1,3-dimethyl-5-fluoro-1H-pyrazole-4-carboxamide, sedaxane, isopyrazam and penthiopyrad;
(ii) azoles selected from cyproconazole, difenoconazole, epoxiconazole, flusi-lazole, fluquinconazole, flutriafol, ipconazole, metconazole, propiconazole, prothioconazole, tebuconazole, cyazofamid, prochloraz, ethaboxam and tri-azoxide;
(iii) heterocyclic compounds selected from famoxadone, fluazinam, cyprodinil, pyrimethanil, fenpropimorph, iprodione, acibenzolar-S-methyl, proquinazid, quinoxyfen, fenpiclonil, captan, fenpropidin, captafol and anilazin;
(iv) carbamates and dithiocarbamates selected from mancozeb, metiram, iprovalicarb, maneb, propineb, flubenthiavalicarb (benthiavalicarb) and propamocarb
(v) organo-chloro compounds selected from thiophanate methyl, chlorothalonil, tolylfluanid and flusulfamid;
(vi) inorganic active ingredients selected from Bordeaux composition, copper acetate, copper hydroxide, copper oxychloride, basic copper sulfate and sulfur;
(vii) various selected from ametoctradin, spiroxamine, cymoxanil, cyflufenamid, valiphenal, metrafenone, fosetly-aluminium and dithianon.

Nitrogen can be stored in a plant in various ways. The main storage forms in plants, however, are inorganic nitrate, organic free amino acids and proteins. In many annual plants, nitrate is an important storage form while proteins as well as free amino acids seem to be the preferred nitrogen storage form in perennial plants such as trees.

The pool of free amino acids in plants is dominated by arginine, asparagin and glutamine. Which of the free amino acids dominates the overall pool of free amino acids mainly depends on the plant species. In recent investigations it was found that the concentration of free amino acid nitrogen is higher in late autumn compared to the summer indicating a central role of free amino acids in winter storage of nitrogen. On the contrary to free amino acids, soluble protein nitrogen does not seem to be important for winter storage of nitrogen because the concentrations did not change between summer and autumn. As a consequence, free amino acids can be regarded as the key storage form of nitrogen in perennial plants.

Interestingly, arginine is used for nitrogen storage independently of the nitrogen availability indicating that arginine can be used for both storage and accumulation. One reason for the preference of many plants towards arginine as one possible form of storage nitrogen may be its low C/N ratio which makes it an effective storage compound especially in energy limited environments (Nordin and Näsholm; 1997; Nitrogen storage forms in nine boreal understorey plant species. Oecologia 110: 487-492).

The storage of nitrogen can often be found in perennial plant species which show extensive storage tissues such as wood and bark. Below-ground structures such as roots and rhizomes are additionally used for storage of nutrients as well as for the uptake of nutrients and water. Due to the presence of storage tissues, perennial plants are able to uncouple growth from current outside nutrient supply which may be limited under certain growth conditions. Many studies have demonstrated the importance of nitrogen availability especially in times when nitrogen demand is very high as it is the case in spring during bud break.

In general, an increase in storage nitrogen such as free amino acids has the advantage that during various periods of the plant development, nitrogen reserves are available. On the contrary to annual plants, perennial plants live much longer (typically more than one year up to over 3000 years). As a consequence, perennial plants have developed special structures that allow them to live over many years and to survive periods of dormancy such as winter or certain stress periods. These structures can be described as storage tissue or storage organs. Typical examples are bulbs, tubers, wood, bark, roots and rhizomes. Among others, those structures are used by the plant for the storage of storage nitrogen.

In temperate climates, the importance of storage nitrogen during autumn regarding the plant development in the following spring has been shown by several studies. It was found for example that there is a highly positive correlation between the level or storage nitrogen in peach and the new shoot growth in the following spring if the current nitrogen application was low. As a consequence, the higher the level of storage nitrogen, the better the development of the plant at the beginning of the next growth period.

The strobilurins (compound A) used in the method according to the present invention are known as fungicides, as compounds having plant health activity and in some cases as insecticides (cf., for example EP-A 178 826, EP-A 278 595, EP-A 253 213, EP-A 254 426, EP-A 398 692, EP-A 477 631, EP-A 628 540, EP-A 280 185, EP-A 350 691, EP-A 460 575, EP-A 463 488, EP-A 382 375, EP-A 398 692, WO 93/15046, WO 95/18789, WO 95/24396, WO 95/21153, WO 95/21154, WO 96/01256, WO 97/05103, WO 97/15552, WO 97/06133, WO 01/82701, WO 03/075663, WO 04/043150 and WO 07/104,660). Their pesticidal action and methods for producing them are generally known.

The further active ingredients (compound B) as well as their pesticidal action and methods for producing them are also generally known.

The commercially available compounds may be found, among others, in “The Pesticide Manual, 14th Edition, British Crop Protection Council (2006)”.

WO 04/1043150 relates to a method for increasing the yield in glyphosate-resistant legumes, which comprises treating the plants or the seed with a mixture comprising a strobilurine and a glyphosate derivate in a synergistically active amount.

WO 06/1089876 describes plant-protecting active ingredient mixtures comprising, as active components, a neonicotinoid and one or two fungicides selected from pyraclostrobin and boscalid, in synergistically effective amounts and to a method of improving the health of plants by applying said mixtures.

WO 08/059,053 relates to a method for increasing the dry biomass of a plant as well increasing its CO₂ sequestration by applying at least on strobilurin. It discloses that strobilurin compounds may induce an enhanced tolerance of the plant towards abiotic stress such as temperature extremes, drought, extreme wetness or radiation, and consequently may improve the plant's ability to store energy in the form of carbohydrates or proteins. However, no hint is given towards the use of strobilurins for increasing the level of free amino acids such as arginine in storage tissues of perennial plants.

U.S. Ser. No. 09/009,4712 provides methods and compositions for making and using transgenic plants that exhibit increased nitrogen storage capacity compared to wild-type plants. The methods comprise inducing the overexpression of monocot-derived vegetative storage proteins (VSPs) in plants.

The mode of action of strobilurins is the inhibition of the mitochondrial respiration by blocking electron transfer in complex III (bc1 complex) of the mitochondrial electron transport chain leading to the breakdown of this essential physiological process (Ammermann et al. 2000; BAS 500F—the new broad spectrum strobilurin fungicide. BCPC Conference, Pests & Diseases, 541-548).

Besides their outstanding broad range fungicidal activity, it is already known from literature that strobilurins are capable of increasing the biomass and yield of plants (Koehle H. et al. 1997; Physiologische Einflüsse des neuen Getreidefungizides Juwel auf die Ertragsbildung. Gesunde Pflanzen 49: 267-271). One of the reasons for the yield increase is attributed to a short term increase in NADH-nitrate reductase (NR) activity which catalyzes the first step of the nitrate assimilation (Glaab and Kaiser 1999; Increased nitrate reductase activity in leaf tissues after application of the fungicide Kresoxim-methyl. Planta 207: 442-448). However, the activation of the NR results only transiently in increased nitrite levels and can therefore improve plant growth only in cases in which the first step in plant nitrogen assimilation is rate limiting. When wheat plants were treated with pyraclostrobin at rates normally used for fungal control at the field site, nitrite and ammonia accumulated following application in the leaves. However, this enhancement of nitrate reduction persisted only for 3 nights after a single application of pyraclostrobin proving the short-term effect of strobilurins on the activity of the NR. Furthermore, it could be shown that neither the relative content of protein nor C/N-ratios were different in control compared to pyraclostrobin treated plants, indicating that the additional uptake and reduction of nitrate was used for enhanced growth instead of increasing the level of storage nitrogen (Koehle et al. 2001; Physiological effects of the strobilurin fungicide F500 on plants. 13^{th} International Reinhardsbrunn Symposium, Friedrichsroda, Germany).

In summary, the effects of pyraclostrobin on nitrogen metabolism known so far were restricted to the very first step in assimilation of anorganic nitrogen, which indeed is the bottleneck during periods of intensive nitrogen demand, for example in shooting stages of cereals. Transient activation of the NR in critical stages of growth, especially when ovules are formed, can improve the yield in annual plants during the growth period directly following the application. However, to date there is no indication for any impact of strobilurins on the translocation and storage of organic nitrogen, nor its impact on the level of free amino acids in storage tissues of perennial plants.

Different to annual crops, perennial plants remobilize and translocate organic nitrogen (such as free amino acids) in early spring when environmental conditions for uptake and assimilation of nitrogen from soil are still unfavorable. This process does not involve activation of NR. For details see Tromp and Ovaa (1971; Spring Mobilization of Storage Nitrogen in Isolated Shoot Sections of Apple. Physiol. Plant. 25: 16-22) who describe the process of mobilization of nitrogenous compounds in trees during spring development as well as changes in the amounts of total nitrogen, protein, soluble nitrogen and of soluble amino acids during leafing-out of the buds.

Millard (1988; The accumulation and storage of nitrogen by herbaceous plants. Plant, Cell and Environment 11: 1-8) discloses that nitrogen is stored if it can be mobilized from one tissue and subsequently reused for the growth or maintenance of another. The consequence of accumulation and storage of nitrogen is particularly considered in relation to the reproductive growth of annual plants. In addition it is stated that nitrate and proteins are the forms of nitrogen most often stored in plants.

Liácer et al. (2008; Arginine and nitrogen storage. Current opinion in structural biology 18: 673-681) propose that when nitrogen is abundant, prokaryotic and eukaryotic oxygen-producing photosynthetic organisms store nitrogen as arginine, by relieving feedback inhibition of the arginine biosynthesis controlling enzyme N-acetylglutamate kinase (NAGK).

However, the above listed publications remain silent with respect to potential effects of strobilurins on the level of free amino acids in storage tissues of perennial plants and their positive impact on the growth of the plants especially during the spring of the following growing season.

Many plants are growing under permanent stress conditions for example in a nutrient-poor environment. Yet, since nitrogen is one of the central elements required for plant growth, a constant deficiency will eventually result in poor growth and minor quality of the crop.

In addition, under certain circumstances such as transient abiotic stress (for example under longer drought periods) or biotic stress (for example after pathogen attack) or at certain developmental periods within the growth period of a plant (for example during the time of bud-break), plants show an increased demand for nitrogen which can not easily be covered by root uptake.

One possibility to overcome this nitrogen deficiency is by applying fertilizers to the plants either in spring or in late fall which is common practice in some perennial plants. Applying fertilizers in the autumn can increase the partitioning of nitrogen towards roots. However, the application of fertilizers displays various disadvantages not only for technical reasons, but also from an economic and ecological stand point. In addition, it is known that the efficiency of nitrogen uptake by roots decreases with rising nitrogen concentration in the soil. Yet another problem of fertilizing might be the increased leaching of nitrogen into the aquifer which is a matter of environmental concern. This is especially a problem when the fertilizers are applied late in the growing season such as in autumn which would be necessary to raise the nitrogen level in plants to a level suitable to outlast winter. Similar holds true for fertilization in early spring when soil temperature still is not high enough to enable biochemical uptake and assimilation of external nitrogen by plants or a fertilization is technically not possible due to wet subsoil.

In addition, the abundant presence of certain amino acids such as arginine is essential for an optimal fermentation process of must to wine. Grapes that display a lack of sufficient nitrogen due to too low amino acid concentrations tend to ferment not fast enough or the fermentation process might even stop. As a consequence, high quality wines (especially dry wines) may not be produced.

One of the problems that can often be observed due to differences in the nitrogen supply of plants is an uneven growth start at the beginning of the growth period in spring. This in term leads to multiple harmful secondary effects based on the resulting uneven growth patterns of the plants. A typical effect may be for example that plants differing in size show a different light interception which directly leads to an uneven fruit ripening, maturation and overall development. Out of this, certain additional technical problems arise for the practioner such as the appropriate estimation and planning of the optimal harvest time point because at harvest, there will be plants that should have been harvested before this time point while others are still not ready for harvest leading to a loss of potential yield and a reduction of quality.

It was therefore an object of the present invention to provide a method which solves the problems outlined above, and which should, in particular, increases the level of free amino acids in storage tissues of perennial plants without the disadvantages of late or very early fertilization.

Within this context, it is a further object of the present invention to provide a method which improves the availability and remobilization of nitrogen in perennial plants for early development and growth in the spring (optimization of nitrogen efficiency).

Yet another object of the present invention is securing the abundant presence of certain amino acids such as arginine in grapevine to ensure an optimal fermentation process.

Surprisingly, we have found that the objects according to the invention are achieved by treating perennial plants with at least one strobilurin (compound A).

It was also found that certain mixtures comprising at least one strobilurin (compound A) and at least one further active ingredient (compound B) were able to increase the level of free amino acids in storage tissues of perennial plants.

Various advantages can be ascribed to an increased level of free amino acids in storage tissues of perennial plants. One is the fact that the capacity for storing and reutilizing nitrogen in the form of free amino acids allows plants to integrate nitrogen acquisition and nitrogen availability over several years. This enables the plants both to lengthen the residence time of nitrogen which may be particularly important for plants which are growing under nutrient-poor conditions in general, and to take advantage of transient periods with high availability of nitrogen to bridge gaps with nitrogen deficiency.

Yet another advantage of abundant amounts of free amino acids in storage tissues (for example in autumn) is their use to support initial growth during leafing-out of the bud (bud break) in the following spring (after the winter season) giving the plants a head-start in development and increasing their vigor. The mobilization of nitrogen from storage tissues and its transport to the growing parts of the plant at a time when nitrogen demand is very high but its uptake by the roots may not yet be fully established and the soil nitrogen mineralization rates are low is essential for successful development. As a consequence, the problems described above such as differences in the nitrogen supply of plants, uneven growth start at the beginning of the growth period in spring, uneven growth patterns of the plants, different light interception, uneven fruit ripening, maturation and overall development, problems in respect of an estimation and planning of the optimal harvest time point can be avoided.

In addition, free amino acids in storage tissues allows a plant to respond to unpredictable events (e.g. herbivory) and facilitates reproduction.

Most evident is the advantage of filled nitrogen reservoirs in plants of which certain plant parts are harvested during the growth period and before the energy-dependant and photosynthesis driven process of nitrogen assimilation starts, which is the case for example for asparagus. When, however, the method according to the invention is applied in asparagus plantations, the level of free amino acids is high enough to support strong growth in the subsequent year, improving significantly the plant quality.

The application of strobilurins according to invention in late season improves the recycling of nitrogen inside the plant by enhanced mobilization of nitrogen from annual parts like leaves and its translocation into storage organs like root. Since uptake and assimilation of nitrogen from soil is an energy consuming process, the plant with better filled nitrogen depots has an advantage for new growth following winter break especially when environmental conditions are suboptimal.

In one embodiment of the invention, the active ingredients applied to the plants belong to the functional class of strobilurins (compound A) selected from the group consisting of pyraclostrobin, orysastrobin, azoxystrobin, dimoxystrobin, enestroburin, fluoxastrobin, kresoxim-methyl, metominostrobin, orysastrobin, picoxystrobin, pyribencarb, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-15 methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)-ethyl]benzyl)carbamate and 2-(2-(3-(2,6-dichlorophenyl)-1-methyl-allylideneaminooxymethyl)-phenyl)-2-methoxyimino-N-methyl-acetamide to the plant.

In another embodiment according to the invention, at least one strobilurin (compound A) is applied which is selected from the group consisting of pyraclostrobin, azoxystrobin, kresoxim-methyl, trifloxystrobin and picoxystrobin.

In a preferred embodiment according to the invention, at least one strobilurin (compound A) is applied which is selected from the group consisting of pyraclostrobin, azoxystrobin, trifloxystrobin and picoxystrobin.

In a more preferred embodiment according to the invention, the active ingredient applied to the plants is pyraclostrobin.

The remarks as to preferred embodiments of the compounds selected from the group consisting of strobilurins (compounds A) and respective mixtures additionally comprising active ingredients selected from the group consisting of at least one compound (B), to their preferred use and methods of using them are to be understood either each on their own or preferably in combination with each other.

The present invention additionally relates to a method for increasing the level of free amino acids in storage tissues of perennial plants comprising the application of at least one strobilurin (compound A) as described above and at least one further active ingredient (compound B) selected from the group consisting of

(i) carboxylic amides selected from fluopyram, boscalid, fenhexamid, metalaxyl, di-methomorph, fluopicolide (picobenzamid), zoxamide, mandipropamid, carpropamid, N-(3′,4′,5′-trifluorobiphenyl-2-yl)-3-difluoromethyl-1-methyl-1H-pyrazole-4-carboxamide, N-[2-(4′-trifluoromethylthio)-biphenyl]-3-difluoromethyl-1-methyl-1H-pyrazole-4-carboxamide, bixafen, N-[2-(1,3-dimethylbutyl)-phenyl]-1,3-dimethyl-5-fluoro-1H-pyrazole-4-carboxamide, sedaxane, isopyrazam and penthiopyrad;
(ii) azoles selected from cyproconazole, difenoconazole, epoxiconazole, flusi-lazole, fluquinconazole, flutriafol, ipconazole, metconazole, propiconazole, prothioconazole, tebuconazole, cyazofamid, prochloraz, ethaboxam and tri-azoxide;
(iii) heterocyclic compounds selected from famoxadone, fluazinam, cyprodinil, pyrimethanil, fenpropimorph, iprodione, acibenzolar-S-methyl, proquinazid, quinoxyfen, fenpiclonil, captan, fenpropidin, captafol and anilazin;
(iv) carbamates and dithiocarbamates selected from mancozeb, metiram, iprovalicarb, maneb, propineb, flubenthiavalicarb (benthiavalicarb) and propamocarb
(v) organo-chloro compounds selected from thiophanate methyl, chlorothalonil, tolylfluanid and flusulfamid;
(vi) inorganic active ingredients selected from Bordeaux composition, copper acetate, copper hydroxide, copper oxychloride, basic copper sulfate and sulfur;
(vii) various selected from ametoctradin, spiroxamine, cymoxanil, cyflufenamid, valiphenal, metrafenone, fosetly-aluminium and dithianon.

In one embodiment according to the invention, this agrochemical mixture comprises

(1) at least one strobilurine (compound A); and
(2) at least one additional active ingredient (compound B), wherein compound (B) is selected from the group consisting of metiram, boscalid, N-(3′,4′,5′-trifluorobiphenyl-2-yl)-3-difluoromethyl-1-methyl-1H-pyrazole-4-carboxamide, epoxiconazole, difenoconazole, metrafenone, dithianon and metconazole.

In another embodiment according to the invention, compound (B) is selected from the group consisting of metiram, boscalid, metrafenone and dithianon.

In a preferred embodiment according to the invention, compound (B) is metiram or boscalid.

In another preferred embodiment according to the invention, compound (B) is metiram.

In one embodiment, the joint or separate application of a mixture comprising at least one compound (A) and at least one compound (B) or the successive application of at least one compound (A) and at least one compound (B) allows increasing the level of free amino acids to a level (concentration) that surpasses the storage levels that is achieved by the application of the individual compounds alone (synergistic mixture). Consequently, in one embodiment of the method according to the invention, the mixture comprising at least one compound (A) and at least one compound (B) can synergistically increase the level of free amino acids in storage tissues of perennial plants.

In the terms of the present invention “mixture” is not restricted to a physical mixture comprising at least one compound (A) and at least one compound (B) but refers to any preparation form of compound (A) and compound (B), the use of which is time- and locus-related. In one embodiment of the invention “mixture” refers to a physical mixture of one compound (A) and one compound (B).

In another embodiment of the invention, “mixture” refers to at least one compound (A) and at least one compound (B) formulated separately but applied to the same plant in a temporal relationship, i.e. simultaneously or subsequently, the subsequent application having a time interval which allows a combined action of the compounds.

Furthermore, the individual compounds of the mixtures according to the invention such as parts of a kit or parts of the binary mixture may be mixed by the user himself in a spray tank and further auxiliaries may be added, if appropriate (tank mix). This applies also in case ternary mixtures are used according to the invention.

Preferably, all above-mentioned mixtures comprise at least one strobilurin selected from the group consisting of pyraclostrobin, azoxystrobin, kresoxim-methyl, trifloxystrobin and picoxystrobin as compound (A). More preferably, these mixtures comprise pyraclostrobin, azoxystrobin, trifloxystrobin as compound (A). Most preferably, these mixtures comprise pyraclostrobin as compound (A).

Thus, with respect to their intended use in the methods of the present invention, the following secondary mixtures listed in table 1, comprising one compound (A) and one compound (B) are a preferred embodiment of the present invention.

TABLE 1

| | Compound (A) | Compound (B) |
|---|---|---|
| M-1 | Pyraclostrobin | Metiram |
| M-2 | Pyraclostrobin | Boscalid |
| M-3 | Pyraclostrobin | N-(3′,4′,5′-trifluorobiphenyl-2-yl)-3- |
| | | difluoromethyl-1-methyl-1H-pyrazole-4- |
| | | carboxamide |
| M-4 | Pyraclostrobin | Epoxiconazole |
| M-5 | Pyraclostrobin | Difenoconazole |
| M-6 | Pyraclostrobin | Metrafenone |
| M-7 | Pyraclostrobin | Dithianon |
| M-8 | Pyraclostrobin | Metconazole |
| M-9 | Azoxystrobin | Metiram |
| M-10 | Azoxystrobin | Boscalid |
| M-11 | Azoxystrobin | N-(3′,4′,5′-trifluorobiphenyl-2-yl)-3- |
| | | difluoromethyl-1-methyl-1H-pyrazole-4- |
| | | carboxamide |
| M-12 | Azoxystrobin | Epoxiconazole |
| M-13 | Azoxystrobin | Difenoconazole |
| M-14 | Azoxystrobin | Metrafenone |
| M-15 | Azoxystrobin | Dithianon |
| M-16 | Azoxystrobin | Metconazole |
| M-17 | Kresoxim-methyl | Metiram |
| M-18 | Kresoxim-methyl | Boscalid |
| M-19 | Kresoxim-methyl | N-(3′,4′,5′-trifluorobiphenyl-2-yl)-3- |
| | | difluoromethyl-1-methyl-1H-pyrazole-4- |
| | | carboxamide |
| M-20 | Kresoxim-methyl | Epoxiconazole |
| M-21 | Kresoxim-methyl | Difenoconazole |
| M-22 | Kresoxim-methyl | Metrafenone |
| M-23 | Kresoxim-methyl | Dithianon |
| M-24 | Kresoxim-methyl | Metconazole |
| M-25 | Trifloxystrobin | Metiram |
| M-26 | Trifloxystrobin | Boscalid |
| M-27 | Trifloxystrobin | N-(3′,4′,5′-trifluorobiphenyl-2-yl)-3- |
| | | difluoromethyl-1-methyl-1H-pyrazole-4- |
| | | carboxamide |
| M-28 | Trifloxystrobin | Epoxiconazole |
| M-29 | Trifloxystrobin | Difenoconazole |
| M-30 | Trifloxystrobin | Metrafenone |
| M-31 | Trifloxystrobin | Dithianon |
| M-32 | Trifloxystrobin | Metconazole |
| M-33 | Picoxystrobin | Metiram |
| M-34 | Picoxystrobin | Boscalid |
| M-35 | Picoxystrobin | N-(3′,4′,5′-trifluorobiphenyl-2-yl)-3- |
| | | difluoromethyl-1-methyl-1H-pyrazole-4- |
| | | carboxamide |
| M-36 | Picoxystrobin | Epoxiconazole |
| M-37 | Picoxystrobin | Difenoconazole |
| M-38 | Picoxystrobin | Metrafenone |
| M-39 | Picoxystrobin | Dithianon |
| M-40 | Picoxystrobin | Metconazole |

Within the mixtures of table 1, the following mixtures are especially preferred: M-1, M-2, M-3, M-4, M-5, M-6, M7 and M-8.

Within this subset, the following mixtures are preferred: M-1, M-2, M-6 and M-7. Utmost preference is given to mixture M1.

In a preferred embodiment of the method according to the invention, an agrochemical mixture comprising pyraclostrobin as compound (A) and metiram as compound (B) is applied.

All mixtures set forth above are also an embodiment of the present invention.

The perennial plants to be treated according to the invention are generally plants of economic importance and/or men-grown plants. The perennial plants are preferably selected from the group consisting of agricultural, silvicultural and horticultural plants, each in its natural or genetically modified form, more preferably from agricultural plants.

In one embodiment of the method according to the invention, the perennial plants to be treated according to the invention are selected from the group consisting of trees, herbaceous plants, shrubs and bulbous plants.

In one embodiment of the method according to the invention, the perennial plants to be treated according to the invention are plants used for producing fruits such as bananas or grapevines.

In one embodiment of the method according to the invention, the perennial plants to be treated according to the invention are vegetables such as asparagus.

In another preferred embodiment of the method according to the invention, the perennial plants to be treated according to the invention are selected from the group consisting of asparagus, grapevine, pomes, bananas, apples, pears, plums, peaches, almonds, cherries, strawberries, raspberries, currant, blackberries, gooseberries, oranges, lemons, grapefruits, mandarins, nut trees, oil palm, tobacco, coffee, tea, hop and turf.

In a preferred embodiment of the invention, the perennial plants to be treated according to the invention are selected from the group consisting of asparagus, grapevine, bananas, apples, pears, oranges, lemons, oil palm, tobacco and coffee.

In a more preferred embodiment of the invention, the perennial plants to be treated according to the invention are selected from the group consisting of asparagus, grapevine and bananas.

In an even more preferred embodiment of the invention, the perennial plants to be treated according to the invention are asparagus or grapevine.

In an especially preferred embodiment of the method according to the invention, the perennial plant to be treated according to the invention is grapevine.

The term “plants” is to be understood as plants of economic importance and/or men-grown plants. They are preferably selected from agricultural, silvicultural and horticultural (including ornamental) plants. The term plant as used herein includes all parts of a plant such as germinating seeds, emerging seedlings, herbaceous vegetation as well as established woody plants including all belowground portions (such as the roots) and aboveground portions.

The term “perennial plant” is to be understood as plants that live for more than one year or a plant that lasts for more than two growing seasons either dying back after each season or growing continuously. Perennial plants include a wide assortment of plant groups which can be grouped to agricultural, silvicultural and horticultural (including ornamental) plants. With respect to their structure and growth habit, they are characterized by specific growth structures like storage tissues which allow them to survive periods of dormancy for example under detrimental growth conditions such as winter or extended drought. While perennial plants tend to grow continuously in warmer and more favorable climates, their growth is limited to defined growing seasons in seasonal climates. In temperate regions for example, a perennial plant may grow and bloom during the warm part of the year while during winter the growth is strongly limited or absent. Perennial plants dominate many natural ecosystems because they display a high competiveness compared to annual plants. This is especially true under poor growing conditions.

The term “agricultural plants” is to be understood as plants of which a part (e.g. seeds, fruits) or all is harvested or cultivated on a commercial scale or which serve as an important source of feed, food, fibres (e.g. cotton, linen), chemical processes (oil, sugar), combustibles (e.g. wood, bio ethanol, biodiesel, biomass) or other chemical compounds. Agricultural plants in general may be annual or perennial plants. They also include horticultural plants, i.e. plants grown in gardens (and not on fields), such as certain fruits and vegetables. Agricultural plants in general are for example cereals, e.g. wheat, rye, barley, triticale, oats, sorghum or rice, beet, e.g. sugar beet or fodder beet; fruits, such as pomes, stone fruits or soft fruits, e.g. apples, pears, plums, peaches, almonds, cherries, strawberries, raspberries, blackberries or gooseberries; leguminous plants, such as lentils, peas, alfalfa or soybeans; oil plants, such as rape, oil-seed rape, canola, linseed, mustard, olives, sunflowers, coconut, cocoa beans, castor oil plants, oil palms, ground nuts or soybeans; cucurbits, such as squashes, cucumber or melons; fibre plants, such as cotton, flax, hemp or jute; citrus fruit, such as oranges, lemons, grapefruits or mandarins; vegetables, such as spinach, lettuce, asparagus, cabbages, carrots, onions, tomatoes, potatoes, cucurbits or paprika; lauraceous plants, such as avocados, cinnamon or camphor; energy and raw material plants, such as corn, soybean, rape, canola (oils seed rape), sugar cane or oil palm, corn, tobacco, nuts, coffee, tea, bananas, vines (table grapes and grape juice grape vines), hop, turf, natural rubber plants or ornamental and forestry plants, such as flowers, shrubs, broad-leaved trees or evergreens (e.g. conifers) and on the plant propagation material, such as seeds, and the crop material of these plants. With respect to the method according to the invention, only those agricultural plants may be treated, that are perennial.

The term “horticultural plants” is generally to be understood as plants which are commonly used in horticulture or for ornamental reasons—e.g. the cultivation of ornamentals, vegetables and/or fruits. Horticultural plants in general may be annual or perennial plants. Examples for ornamentals are turf, geranium, pelargonia, petunia, begonia, and fuchsia, to name just a few among the vast number of ornamentals. Examples for vegetables potatoes, tomatoes, peppers, cucurbits, cucumbers, melons, watermelons, garlic, onions, carrots, cabbage, beans, peas and lettuce and more preferably from tomatoes, onions, peas and lettuce, to name just a few among the vast number of vegetables. Examples for fruits are apples, pears, cherries, strawberry, citrus, peaches, apricots, blueberries, to name just a few among the vast number of fruits. With respect to the method according to the invention, only those horticultural plants may be treated, that are perennial.

The term “silvicultural plants” is to be understood as trees, more specifically trees used in forestation or industrial plantations. Industrial plantations generally serve for the commercial production of forest products, such as wood, pulp, paper, rubber tree, Christmas trees, or young trees for gardening purposes. Trees are typically perennial plants. Examples for silvicultural plants are conifers, like pines, in particular Pinus spec., fir and spruce, eucalyptus, tropical trees like teak, rubber tree, oil palm, willow (Salix), in particular Salix spec., poplar (cottonwood), in particular Populus spec., beech, in particular Fagus spec., birch, oil palm, and oak. With respect to the method according to the invention, only those silvicultural plants may be treated, that are perennial.

Generally the term “plants” also includes plants which have been modified by breeding, mutagenesis or genetic engineering.

The term “genetically modified plants” is to be understood as plants, which genetic material has been modified by the use of recombinant DNA techniques in a way that under natural circumstances it cannot readily be obtained by cross breeding, mutations or natural recombination. Typically, one or more genes have been integrated into the genetic material of a genetically modified plant in order to improve certain properties of the plant. Such genetic modifications also include but are not limited to targeted post-translational modification of protein(s), oligo- or polypeptides e.g. by glycosylation or polymer additions such as prenylated, acetylated or farnesylated moieties or PEG moieties. Plants that have been modified by breeding, mutagenesis or genetic engineering, e.g. have been rendered tolerant to applications of specific classes of herbicides, such as hydroxyphenylpyruvate dioxygenase (HPPD) inhibitors; acetolactate synthase (ALS) inhibitors, such as sulfonyl ureas (see e.g. U.S. Pat. No. 6,222,100, WO 01/82685, WO 00/26390, WO 97/41218, WO 98/02526, WO 98/02527, WO 04/106529, WO 05/20673, WO 03/14357, WO 03/13225, WO 03/14356, WO 04/16073) or imidazolinones (see e.g. U.S. Pat. No. 6,222,100, WO 01/82685, WO 00/026390, WO 97/41218, WO 98/002526, WO 98/02527, WO 04/106529, WO 05/20673, WO 03/014357, WO 03/13225, WO 03/14356, WO 04/16073); enolpyruvylshikimate-3-phosphate synthase (EPSPS) inhibitors, such as glyphosate (see e.g. WO 92/00377); glutamine synthetase (GS) inhibitors, such as glufosinate (see e.g. EP-A 242 236, EP-A 242 246) or oxynil herbicides (see e.g. U.S. Pat. No. 5,559,024) as a result of conventional methods of breeding or genetic engineering. Several cultivated plants have been rendered tolerant to herbicides by conventional methods of breeding (mutagenesis), e.g. Clearfield® summer rape (Canola, BASF SE, Germany) being tolerant to imidazolinones, e.g. imazamox. Genetic engineering methods have been used to render cultivated plants such as soybean, cotton, corn, beets and rape, tolerant to herbicides such as glyphosate and glufosinate, some of which are commercially available under the trade names RoundupReady® (glyphosate-tolerant, Monsanto, U.S.A.) and LibertyLink® (glufosinate-tolerant, Bayer CropScience, Germany). Furthermore, plants are also covered that are by the use of recombinant DNA techniques capable to synthesize one or more insecticidal proteins, especially those known from the bacterial genus Bacillus, particularly from Bacillus thuringiensis, such as δ-endotoxins, e.g. CryIA(b), CryIA(c), CryIF, CryIF(a2), CryIIA(b), CryIIIA, CryIIIB(b1) or Cry9c; vegetative insecticidal proteins (VIP), e.g. VIP1, VIP2, VIP3 or VIP3A; insecticidal proteins of bacteria colonizing nematodes, e.g. Photorhabdus spp. or Xenorhabdus spp.; toxins produced by animals, such as scorpion toxins, arachnid toxins, wasp toxins, or other insect-specific neurotoxins; toxins produced by fungi, such Streptomycetes toxins, plant lectins, such as pea or barley lectins; agglutinins; proteinase inhibitors, such as trypsin inhibitors, serine protease inhibitors, patatin, cystatin or papain inhibitors; ribosome-inactivating proteins (RIP), such as ricin, maize-RIP, abrin, luffin, saporin or bryodin; steroid metabolism enzymes, such as 3-hydroxysteroid oxidase, ecdysteroid-IDP-glycosyl-transferase, cholesterol oxidases, ecdysone inhibitors or HMG-CoA-reductase; ion channel blockers, such as blockers of sodium or calcium channels; juvenile hormone esterase; diuretic hormone receptors (helicokinin receptors); stilben synthase, bibenzyl synthase, chitinases or glucanases. In the context of the present invention these insecticidal proteins or toxins are to be understood expressly also as pre-toxins, hybrid proteins, truncated or otherwise modified proteins. Hybrid proteins are characterized by a new combination of protein domains, (see, e.g. WO 02/015701). Further examples of such toxins or genetically modified plants capable of synthesizing such toxins are disclosed, e.g. in EP A 374 753, WO 93/007278, WO 95/34656, EP A 427 529, EP A 451 878, WO 03/18810 and WO 03/52073. The methods for producing such genetically modified plants are generally known to the person skilled in the art and are described, e.g. in the publications mentioned above. These insecticidal proteins contained in the genetically modified plants impart to the plants producing these proteins tolerance to harmful pests from all taxonomic groups of athropods, especially to beetles (Coeloptera), two-winged insects (Diptera), and moths (Lepidoptera) and to nematodes (Nematoda). Genetically modified plants capable to synthesize one or more insecticidal proteins are, e.g., described in the publications mentioned above, and some of which are commercially available such as YieldGard® (corn cultivars producing the Cry1Ab toxin), YieldGard® Plus (corn cultivars producing Cry1Ab and Cry3Bb1 toxins), Starlink® (corn cultivars producing the Cry9c toxin), Herculex® RW (corn cultivars producing Cry34Ab1, Cry35Ab1 and the enzyme Phosphinothricin-N-Acetyltransferase [PAT]); NuCOTN® 33B (cotton cultivars producing the Cry1Ac toxin), Bollgard® I (cotton cultivars producing the Cry1Ac toxin), Bollgard® II (cotton cultivars producing Cry1Ac and Cry2Ab2 toxins); VIPCOT® (cotton cultivars producing a VIP-toxin); NewLeaf® (potato cultivars producing the Cry3A toxin); Bt-Xtra®, NatureGard®, KnockOut®, BiteGard®, Protecta®, Bt11 (e.g. Agrisure® CB) and Bt176 from Syngenta Seeds SAS, France, (corn cultivars producing the Cry1Ab toxin and PAT enyzme), MIR604 from Syngenta Seeds SAS, France (corn cultivars producing a modified version of the Cry3A toxin, c.f. WO 03/018810), MON 863 from Monsanto Europe S.A., Belgium (corn cultivars producing the Cry3Bb1 toxin), IPC 531 from Monsanto Europe S.A., Belgium (cotton cultivars producing a modified version of the Cry1Ac toxin) and 1507 from Pioneer Overseas Corporation, Belgium (corn cultivars producing the Cry1F toxin and PAT enzyme).

Furthermore, plants are also covered that are by the use of recombinant DNA techniques capable to synthesize one or more proteins to increase the resistance or tolerance of those plants to bacterial, viral or fungal pathogens. Examples of such proteins are the so-called “pathogenesis-related proteins” (PR proteins, see, e.g. EP A 392 225), plant disease resistance genes (e.g. potato cultivars, which express resistance genes acting against Phytophthora infestans derived from the Mexican wild potato Solanum bulbocastanum) or T4-lysozym (e.g. potato cultivars capable of synthesizing these proteins with increased resistance against bacteria such as Erwinia amylvora). The methods for producing such genetically modified plants are generally known to the person skilled in the art and are described, e.g. in the publications mentioned above.

Furthermore, plants are also covered that are by the use of recombinant DNA techniques capable to synthesize one or more proteins to increase the productivity (e.g. biomass production, grain yield, starch content, oil content or protein content, free amino acid content), tolerance to drought, salinity or other growth-limiting environmental factors or tolerance to pests and fungal, bacterial or viral pathogens of those plants.

Furthermore, plants are also covered that contain by the use of recombinant DNA techniques a modified amount of substances of content or new substances of content, specifically to improve human or animal nutrition, e.g. oil crops that produce health-promoting long-chain omega-3 fatty acids or unsaturated omega-9 fatty acids (e.g. Nexera® rape, DOW Agro Sciences, Canada).

Furthermore, plants are also covered that contain by the use of recombinant DNA techniques a modified amount of substances of content or new substances of content, specifically to improve raw material production, e.g. potatoes that produce increased amounts of amylopectin (e.g. Amflora® potato, BASF SE, Germany).

In the terms of the present invention a “mixture” means a combination of at least two active ingredients (e.g. compound A and compound B). Consequently, a mixture may be a secondary, ternary or even quaternary mixture.

The term “at least one compound” is to be understood as 1, 2, 3 or more compounds (e.g. strobilurins).

The term “synergistically” means that the purely additive (in mathematical terms) effects of a simultaneous, that is joint or separate application of at least one compound (A) and at least one compound (B) or their successive application is surpassed by the application of a mixture according to the invention.

The term “synergistically the level of free amino acids increasing amounts” means that the mixture according to the invention is applied in amounts which increase the level of free amino acids in a manner which surpasses the purely additive (in mathematical terms) effect of a simultaneous, that is joint or separate application of at least one compound (A) and at least one compound (B) or a successive application of at least one compound (A) and at least one compound (B).

The term “storage nitrogen” is to be understood as any form of organic nitrogen that may be stored by the plant in certain storage tissues. The main storage forms of organic nitrogen in perennial plants are free amino acids and proteins.

According to the invention, the storage nitrogen is stored in the storage tissues of a perennial plant in the form of free amino acids.

In another preferred embodiment of the method according to the invention, the storage nitrogen is stored in the plant as a free amino acid selected from the group consisting of arginine, asparagine, glutamine, aspartic acid, threonine, serine, glutamic acid, alanine, proline, glycine, valine, isoleucine, leucine, tyrosine, phenylalanine, lysine and histidine.

In yet another preferred embodiment of the method according to the invention, the storage nitrogen is stored in the plant as a free amino acid selected from the group consisting of arginine, asparagine and glutamine.

In a more preferred embodiment of the method according to the invention, the storage nitrogen is stored in the plant in the form of arginine.

In the terms of the present invention, “increasing the level of free amino acids in storage tissues of a perennial plants” refers to an increase in the concentration of free amino acids in the plant, plant part (such as storage tissue or storage organ) or plant cell thereof, of at least 5%, 10%, 20%, 30%, 40%, 50% or even more relative to that observed in the respective control plant.

According to one embodiment of the invention, the increase of the level of storage nitrogen is at least 2 to 10%, preferably 10 to 20% more preferably 20 to 40% or even 40 to 80%.

In one embodiment of the invention, the free amino acid concentration is increased by 15 to 30%.

In a preferred embodiment of the invention, storage nitrogen is stored as free amino acids in storage tissues of the plant selected from the group consisting of bark, wood, root, tubers, bulbs, pseudobulb, caudex, taproot, corm, storage hypocotyl and rhizomes.

In another preferred embodiment of the invention, storage nitrogen is stored in roots or rhizomes.

In another preferred embodiment of the invention, storage nitrogen is stored in bark or wood of above- or below ground plant parts such as branches or roots.

The term “storage tissue” is to be understood as any kind of plant tissue typically being part of storage organs which has the capacity to store certain elements or molecules such as nutrients, amino acids and/or water. Storage tissues can be found above and under ground. Among others, bark (e.g. of branches), wood, root, tubers, bulbs, pseudobulb, caudex, taproot, corm, storage hypocotyl and rhizomes are used as storage tissue by the plant.

The term “BBCH principal growth stage” refers to the extended BBCH-scale which is a system for a uniform coding of phenologically similar growth stages of all mono- and dicotyledonous plant species in which the entire developmental cycle of the plants is subdivided into clearly recognizable and distinguishable longer-lasting developmental phases. The BBCH-scale uses a decimal code system, which is divided into principal and secondary growth stages. The abbreviation BBCH derives from the Federal Biological Research Centre for Agriculture and Forestry (Germany), the Bundessortenamt (Germany) and the chemical industry.

The term “vegetative growth period” is to be understood as the non-reproductive growth phase of a plant characterized by plant growth of nodes, internodes and leaves (BBCH GS 10 to 49). The term is used to differentiate from “generative or reproductive growth” (BBCH GS 49 to 89), which is characterized by flowering, pollination and seed growth.

The term “plant growth” is to be understood as the increase of cell number and cell size. Plant growth by repeated cell division of undifferentiated cells occurs in tissues called meristems and is typically followed by growth due to stretching and swelling during the process of cell differentiation.

The term “following the period of vegetative growth” is to be understood as the growth stages of a plant which are characterized by the completion of vegetative and start of generative or reproductive growth. From a physiological point of view, the plants are still very active at this time point, transporting elements and molecules (such as nitrogen compounds) from the leaves (source) to the storage tissues (or storage organs) such as roots which function as sinks.

The term “following the period of reproductive growth” is to be understood as the growth stages of a plant which are characterized by the completion of reproductive growth stages. From a physiological point of view, ripening and maturity of fruits and seeds are completed, senescence and dormancy slowly begin. However, transport processes are still active transporting elements and molecules (such as nitrogen compounds) from the leaves (source) to the storage tissues (or storage organs) such as roots which function as sinks.

In one embodiment of the invention, the respective application is carried out during the reproductive growth phase.

In another embodiment of the invention, the respective application is carried out following the period of reproductive growth. Applying the compounds or mixtures according to the invention at this time of the growing season has various advantages such as the fact that the application takes place after e.g. the fruits have been harvested. Consequently, the exposure of the fruits to agrochemical compounds is reduced. As a result, in a preferred embodiment of the invention, the respective application is carried out at any BBCH principal growth stage (GS) following GS 91 which is characterized by the beginning of dormancy.

The application according to the invention comprising either at least one strobilurin (compound A) or the agrochemical mixtures as described above comprising at least one compound (A) and at least one compound (B) is carried out following the period of vegetative growth, preferably it is carried out four weeks, more preferably six weeks following the period of vegetative growth of the plants.

If a mixture according to the present invention is used in this inventive method, the plants are preferably treated simultaneously (together or separately) or subsequently with the strobilurin (compound A) and at least one further active ingredient (compound B).

The subsequent application is carried out with a time interval which allows a combined action of the applied compounds. Preferably, the time interval for a subsequent application of at least one compound (A) and at least one compound (B) ranges from a few seconds up to 3 months, preferably, from a few seconds up to 1 month, more preferably from a few seconds up to 2 weeks, even more preferably from a few seconds up to 3 days and in particular from 1 second up to 24 hours.

The method according to the invention is preferably carried out as foliar application.

In one embodiment, more than one application and up to 5 applications during a growing season are carried out. Preferably the application is carried out at least twice.

For the use according to the method of the invention, the application rates are between 0.01 and 2.0 kg of active ingredient per hectare, depending on the plant species.

As a matter of course, compound (A) and in case mixtures are employed, at least one compound (A) and at least one compound (B) are used in effective and non-phytotoxic amounts. This means that they are used in a quantity which allows to obtain the desired effect but which does not give rise to any phytotoxic symptom on the treated plant.

In the methods according to the invention, the application rates of the mixtures according to the invention are from 0.3 g/ha to 2500 g/ha, preferably 5 g/ha to 2500 g/ha, more preferably from 20 to 2000 g/ha, in particular from 20 to 1500 g/ha, depending on the type of compound and the desired effect.

The weight ratio of compound (A) to a compound (B) is preferably from 200:1 to 1:200, more preferably from 100:1 to 1:100, more preferably from 50:1 to 1:50 and in particular from 20:1 to 1:20. The utmost preferred ratio is 1:10 to 10:1. The weight ratio refers to the total weight of compound (A) and compound (B) in the mixture.

In one embodiment, the mixtures used according to the method of the present invention, comprising at least one compound (A) and at least one compound (B) are employed in amounts that result in a synergistic increase of the free amino acids in the storage tissues of perennial plants.

The compounds according to the invention can be present in different crystal modifications whose biological activity may differ. They are likewise subject matter of the present invention.

The compounds according to the invention, their N-oxides and salts can be converted into customary types of agrochemical compositions, e.g. solutions, emulsions, suspensions, dusts, powders, pastes and granules. The composition type depends on the particular intended purpose; in each case, it should ensure a fine and uniform distribution of the compound according to the invention.

Examples for composition types are suspensions (SC, OD, FS), emulsifiable concentrates (EC), emulsions (EW, EO, ES), microemulsions (ME), pastes, pastilles, wettable powders or dusts (WP, SP, SS, WS, DP, DS) or granules (GR, FG, GG, MG), which can be water-soluble or wettable, as well as gel formulations for the treatment of plant propagation materials such as seeds (GF). Usually the composition types (e.g. SC, OD, FS, EC, WG, SG, WP, SP, SS, WS, GF) are employed diluted. Composition types such as DP, DS, GR, FG, GG and MG are usually used undiluted.

The compositions are prepared in a known manner (cf. U.S. Pat. No. 3,060,084, EP-A 707 445 (for liquid concentrates), Browning: “Agglomeration”, Chemical Engineering, Dec. 4, 1967, 147-48, Perry's Chemical Engineer's Handbook, 4th Ed., McGraw-Hill, New York, 1963, S. 8-57 and ff. WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2,095,558, U.S. Pat. No. 3,299,566, Klingman: Weed Control as a Science (J. Wiley & Sons, New York, 1961), Hance et al.: Weed Control Handbook (8th Ed., Blackwell Scientific, Oxford, 1989) and Mollet, H. and Grubemann, A.: Formulation technology (Wiley VCH Verlag, Weinheim, 2001).

The agrochemical compositions may also comprise auxiliaries which are customary in agrochemical compositions. The auxiliaries used depend on the particular application form and active substance, respectively. Examples for suitable auxiliaries are solvents, solid carriers, dispersants or emulsifiers (such as further solubilizers, protective colloids, surfactants and adhesion agents), organic and anorganic thickeners, bactericides, anti-freezing agents, anti-foaming agents, if appropriate colorants and tackifiers or binders (e.g. for seed treatment formulations).

Suitable solvents are water, organic solvents such as mineral oil fractions of medium to high boiling point, such as kerosene or diesel oil, furthermore coal tar oils and oils of vegetable or animal origin, aliphatic, cyclic and aromatic hydrocarbons, e.g. toluene, xylene, paraffin, tetrahydronaphthalene, alkylated naphthalenes or their derivatives, alcohols such as methanol, ethanol, propanol, butanol and cyclohexanol, glycols, ketones such as cyclohexanone and gamma-butyrolactone, fatty acid dimethylamides, fatty acids and fatty acid esters and strongly polar solvents, e.g. amines such as N-methylpyrrolidone. Solid carriers are mineral earths such as silicates, silica gels, talc, kaolins, limestone, lime, chalk, bole, loess, clays, dolomite, diatomaceous earth, calcium sulfate, magnesium sulfate, magnesium oxide, ground synthetic materials, fertilizers, such as, e.g., ammonium sulfate, ammonium phosphate, ammonium nitrate, ureas, and products of vegetable origin, such as cereal meal, tree bark meal, wood meal and nutshell meal, cellulose powders and other solid carriers.

Suitable surfactants (adjuvants, wetters, tackifiers, dispersants or emulsifiers) are alkali metal, alkaline earth metal and ammonium salts of aromatic sulfonic acids, such as ligninsoulfonic acid (Borresperse® types, Borregard, Norway) phenolsulfonic acid, naphthalenesulfonic acid (Morwet® types, Akzo Nobel, U.S.A.), dibutylnaphthalene-sulfonic acid (Nekal® types, BASF, Germany), and fatty acids, alkylsulfonates, alkylarylsulfonates, alkyl sulfates, laurylether sulfates, fatty alcohol sulfates, and sulfated hexa-, hepta- and octadecanolates, sulfated fatty alcohol glycol ethers, furthermore condensates of naphthalene or of naphthalenesulfonic acid with phenol and formaldehyde, polyoxy-ethylene octylphenyl ether, ethoxylated isooctylphenol, octylphenol, nonylphenol, alkylphenyl polyglycol ethers, tributylphenyl polyglycol ether, tristearyl┐phenyl polyglycol ether, alkylaryl polyether alcohols, alcohol and fatty alcohol/ethylene oxide condensates, ethoxylated castor oil, polyoxyethylene alkyl ethers, ethoxylated polyoxypropylene, lauryl alcohol polyglycol ether acetal, sorbitol esters, lignin-sulfite waste liquors and proteins, denatured proteins, polysaccharides (e.g. methylcellulose), hydrophobically modified starches, polyvinyl alcohols (Mowiol® types, Clariant, Switzerland), polycarboxylates (Sokolan® types, BASF, Germany), polyalkoxylates, polyvinylamines (Lupasol® types, BASF, Germany), polyvinylpyrrolidone and the copolymers thereof.

Examples for thickeners (i.e. compounds that impart a modified flowability to compositions, i.e. high viscosity under static conditions and low viscosity during agitation) are polysaccharides and organic and anorganic clays such as Xanthan gum (Kelzan®, CP Kelco, U.S.A.), Rhodopol® 23 (Rhodia, France), Veegum® (R.T. Vanderbilt, U.S.A.) or Attaclay® (Engelhard Corp., NJ, USA).

Bactericides may be added for preservation and stabilization of the composition. Examples for suitable bactericides are those based on dichlorophene and benzylalcohol hemi formal (Proxel® from ICI or Acticide® RS from Thor Chemie and Kathon® MK from Rohm & Haas) and isothiazolinone derivatives such as alkylisothiazolinones and benzisothiazolinones (Acticide® MBS from Thor Chemie).

Examples for suitable anti-freezing agents are ethylene glycol, propylene glycol, urea and glycerin.

Examples for anti-foaming agents are silicone emulsions (such as e.g. Silikon® SRE, Wacker, Germany or Rhodorsil®, Rhodia, France), long chain alcohols, fatty acids, salts of fatty acids, fluoroorganic compounds and mixtures thereof.

Suitable colorants are pigments of low water solubility and water-soluble dyes. Examples to be mentioned and the designations rhodamin B, C. I. pigment red 112, C. I. solvent red 1, pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples for tackifiers or binders are polyvinylpyrrolidons, polyvinylacetates, polyvinyl alcohols and cellulose ethers (Tylose®, Shin-Etsu, Japan). Powders, materials for spreading and dusts can be prepared by mixing or concomitantly grinding the compounds I and, if appropriate, further active substances, with at least one solid carrier. Granules, e.g. coated granules, impregnated granules and homogeneous granules, can be prepared by binding the active substances to solid carriers. Examples of solid carriers are mineral earths such as silica gels, silicates, talc, kaolin, attaclay, limestone, lime, chalk, bole, loess, clay, dolomite, diatomaceous earth, calcium sulfate, magnesium sulfate, magnesium oxide, ground synthetic materials, fertilizers, such as, e.g. ammonium sulfate, ammonium phosphate, ammonium nitrate, ureas, and products of vegetable origin, such as cereal meal, tree bark meal, wood meal and nutshell meal, cellulose powders and other solid carriers.

Examples for composition types are:

1. Composition Types for Dilution with Water
i) Water-soluble concentrates (SL, LS)

10 parts by weight of a compound I according to the invention are dissolved in 90 parts by weight of water or in a water-soluble solvent. As an alternative, wetting agents or other auxiliaries are added. The active substance dissolves upon dilution with water. In this way, a composition having a content of 10% by weight of active substance is obtained.

### ii) Dispersible Concentrates (DC)

20 parts by weight of a compound I according to the invention are dissolved in 70 parts by weight of cyclohexanone with addition of 10 parts by weight of a dispersant, e.g. polyvinylpyrrolidone. Dilution with water gives a dispersion. The active substance content is 20% by weight.

iii) Emulsifiable Concentrates (EC)

15 parts by weight of a compound I according to the invention are dissolved in 75 parts by weight of xylene with addition of calcium dodecylbenzenesulfonate and castor oil ethoxylate (in each case 5 parts by weight). Dilution with water gives an emulsion. The composition has an active substance content of 15% by weight.

### iv) Emulsions (EW, EO, ES)

25 parts by weight of a compound I according to the invention are dissolved in 35 parts by weight of xylene with addition of calcium dodecylbenzenesulfonate and castor oil ethoxylate (in each case 5 parts by weight). This mixture is introduced into 30 parts by weight of water by means of an emulsifying machine (Ultraturrax) and made into a homogeneous emulsion. Dilution with water gives an emulsion. The composition has an active substance content of 25% by weight.

### v) Suspensions (SC, OD, FS)

In an agitated ball mill, 20 parts by weight of a compound I according to the invention are comminuted with addition of 10 parts by weight of dispersants and wetting agents and 70 parts by weight of water or an organic solvent to give a fine active substance suspension. Dilution with water gives a stable suspension of the active substance. The active substance content in the composition is 20% by weight.

### vi) Water-Dispersible Granules And Water-Soluble Granules (WG, SG)

50 parts by weight of a compound I according to the invention are ground finely with addition of 50 parts by weight of dispersants and wetting agents and prepared as water-dispersible or water-soluble granules by means of technical appliances (e.g. extrusion, spray tower, fluidized bed). Dilution with water gives a stable dispersion or solution of the active substance. The composition has an active substance content of 50% by weight.

vii) Water-Dispersible Powders and Water-Soluble Powders (WP, SP, SS, WS)

75 parts by weight of a compound I according to the invention are ground in a rotor-stator mill with addition of 25 parts by weight of dispersants, wetting agents and silica gel. Dilution with water gives a stable dispersion or solution of the active substance. The active substance content of the composition is 75% by weight.

viii) Gel (GF)

In an agitated ball mill, 20 parts by weight of a compound I according to the invention are comminuted with addition of 10 parts by weight of dispersants, 1 part by weight of a gelling agent wetters and 70 parts by weight of water or of an organic solvent to give a fine suspension of the active substance. Dilution with water gives a stable suspension of the active substance, whereby a composition with 20% (w/w) of active substance is obtained.

### 2. Composition Types to be Applied Undiluted

### ix) Dustable Powders (DP, DS)

5 parts by weight of a compound I according to the invention are ground finely and mixed intimately with 95 parts by weight of finely divided kaolin. This gives a dustable composition having an active substance content of 5% by weight.

### x) Granules (GR, FG, GG, MG)

0.5 parts by weight of a compound I according to the invention is ground finely and associated with 99.5 parts by weight of carriers. Current methods are extrusion, spray-drying or the fluidized bed. This gives granules to be applied undiluted having an active substance content of 0.5% by weight.

### xi) ULV Solutions (UL)

10 parts by weight of a compound I according to the invention are dissolved in 90 parts by weight of an organic solvent, e.g. xylene. This gives a composition to be applied undiluted having an active substance content of 10% by weight.

The agrochemical compositions generally comprise between 0.01 and 95%, preferably between 0.1 and 90%, most preferably between 0.5 and 90%, by weight of active substance. The active substances are employed in a purity of from 90% to 100%, preferably from 95% to 100% (according to NMR spectrum).

Water-soluble concentrates (LS), flowable concentrates (FS), powders for dry treatment (DS), water-dispersible powders for slurry treatment (WS), water-soluble powders (SS), emulsions (ES) emulsifiable concentrates (EC) and gels (GF) are usually employed for the purposes of treatment of plant propagation materials, particularly seeds. These compositions can be applied to plant propagation materials, particularly seeds, diluted or undiluted. The compositions in question give, after two-to-tenfold dilution, active substance concentrations of from 0.01 to 60% by weight, preferably from 0.1 to 40% by weight, in the ready-to-use preparations. Application can be carried out before or during sowing. Methods for applying or treating agrochemical compounds and compositions thereof, respectively, on to plant propagation material, especially seeds, are known in the art, and include dressing, coating, pelleting, dusting, soaking and in-furrow application methods of the propagation material. In a preferred embodiment, the compounds or the compositions thereof, respectively, are applied on to the plant propagation material by a method such that germination is not induced, e.g. by seed dressing, pelleting, coating and dusting.

In a preferred embodiment, a suspension-type (FS) composition is used for seed treatment. Typically, a FS composition may comprise 1-800 g/l of active substance, 1 200 g/l surfactant, 0 to 200 g/l antifreezing agent, 0 to 400 g/l of binder, 0 to 200 g/l of a pigment and up to 1 liter of a solvent, preferably water.

The active substances can be used as such or in the form of their compositions, e.g. in the form of directly sprayable solutions, powders, suspensions, dispersions, emulsions, oil dispersions, pastes, dustable products, materials for spreading, or granules, by means of spraying, atomizing, dusting, spreading, brushing, immersing or pouring. The application forms depend entirely on the intended purposes; it is intended to ensure in each case the finest possible distribution of the active substances according to the invention.

Aqueous application forms can be prepared from emulsion concentrates, pastes or wettable powders (sprayable powders, oil dispersions) by adding water. To prepare emulsions, pastes or oil dispersions, the substances, as such or dissolved in an oil or solvent, can be homogenized in water by means of a wetter, tackifier, dispersant or emulsifier. Alternatively, it is possible to prepare concentrates composed of active substance, wetter, tackifier, dispersant or emulsifier and, if appropriate, solvent or oil, and such concentrates are suitable for dilution with water.

The active substance concentrations in the ready-to-use preparations can be varied within relatively wide ranges. In general, they are from 0.0001 to 10%, preferably from 0.001 to 1% by weight of active substance.

The active substances may also be used successfully in the ultra-low-volume process (ULV), it being possible to apply compositions comprising over 95% by weight of active substance, or even to apply the active substance without additives.

Various types of oils, wetters, adjuvants, herbicides, bactericides, other fungicides and/or pesticides may be added to the active substances or the compositions comprising them, if appropriate not until immediately prior to use (tank mix). These agents can be admixed with the compositions according to the invention in a weight ratio of 1:100 to 100:1, preferably 1:10 to 10:1. Adjuvants which can be used are in particular organic modified polysiloxanes such as Break Thru S 240®; alcohol alkoxylates such as Atplus 245®, Atplus MBA 1303®, Plurafac LF 300® and Lutensol ON 30®; EO/PO block polymers, e.g. Pluronic RPE 2035® and Genapol B®; alcohol ethoxylates such as Lutensol XP 80®; and dioctyl sulfosuccinate sodium such as Leophen RA®.

The compositions according to the invention can also be present together with other active substances, e.g. with herbicides, insecticides, growth regulators, fungicides or else with fertilizers, as pre-mix or, if appropriate, not until immediately prior to use (tank mix).

The following examples are intended to illustrate the invention, but without imposing any limitation.

### EXAMPLES

### Example 1

As an example to demonstrate the increase of free amino acids in storage tissues according to the invention, the content of the free amino acid arginine was monitored in grapevine plants grown in Brazil, following the application of a mixture according to the invention comprising pyraclostrobin (compound A) and metiram (compound B). Analysis were carried out both in the bark of branches as well as in roots as enduring storage tissues (organs) and sites of nitrogen storage during winter. 6 samples per randomized plot located in three different areas were frozen directly at the field site in liquid nitrogen and stored at −30° C. until extraction and analysis by LC/MS/MS.

Surprisingly, grapevine plants treated according to the method of the invention contained higher concentrations of arginine at the time of sampling compared to plants grown under the growers standard program (control) set as 100%. The arginine concentration in the bark of branches was on the average 18% higher than under control conditions. In roots of treated plants, the arginine concentration was even 27% higher than in the respective control samples.

The results clearly show that the treatment of plants according to invention has a strong influence on the level of free amino acids such as arginine. Although the treated plants had higher yields, the plants obviously were not “out powered”. On the contrary, the treated grapevine plants additionally build up higher reserves of organic nitrogen in enduring wood and roots. This circumstance will clearly give the plants, treated according to the invention, a head start in development during the following growing season in spring.

1-15. (canceled)

16. A method for increasing the level of free amino acids in storage tissues of a perennial plant comprising applying to the plant at least one strobilurin compound (A) selected from the group consisting of pyraclostrobin, orysastrobin, azoxystrobin, dimoxystrobin, enestroburin, fluoxastrobin, kresoxim-methyl, metominostrobin, orysastrobin, picoxystrobin, pyribencarb, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-15 methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)-ethyl]benzyl)carbamate, and 2-(2-(3-(2,6-dichlorophenyl)-1-methyl-allylideneaminooxymethyl)-phenyl)-2-methoxyimino-N-methyl-acetamide following the period of vegetative growth.

17. The method according to claim 16, wherein the at least one strobilurin compound (A) is selected from the group consisting of pyraclostrobin, azoxystrobin, kresoxim-methyl, trifloxystrobin, and picoxystrobin.

18. The method according to claim 16, further comprising applying at least one further active ingredient compound (B) selected from the group consisting of
(i) a carboxylic amide selected from the group consisting of fluopyram, boscalid, fenhexamid, metalaxyl, di-methomorph, fluopicolide (picobenzamid), zoxamide, mandipropamid, carpropamid, N-(3′,4′,5′-trifluorobiphenyl-2-yl)-3-difluoromethyl-1-methyl-1H-pyrazole-4-carboxamide, N-[2-(4′-trifluoromethylthio)-biphenyl]-3-difluoromethyl-1-methyl-1H-pyrazole-4-carboxamide, bixafen, N-[2-(1,3-dimethylbutyl)-phenyl]-1,3-dimethyl-5-fluoro-1H-pyrazole-4-carboxamide, sedaxane, isopyrazam, and penthiopyrad;
(ii) an azole selected from the group consisting of cyproconazole, difenoconazole, epoxiconazole, flusi-lazole, fluquinconazole, flutriafol, ipconazole, metconazole, propiconazole, prothioconazole, tebuconazole, cyazofamid, prochloraz, ethaboxam, and tri-azoxide;
(iii) a heterocyclic compound selected from the group consisting of famoxadone, fluazinam, cyprodinil, pyrimethanil, fenpropimorph, iprodione, acibenzolar-S-methyl, proquinazid, quinoxyfen, fenpiclonil, captan, fenpropidin, captafol, and anilazin;
(iv) a carbamate or dithiocarbamate compound selected from the group consisting of mancozeb, metiram, iprovalicarb, maneb, propineb, flubenthiavalicarb (benthiavalicarb), and propamocarb;
(v) an organo-chloro compound selected from the group consisting of thiophanate methyl, chlorothalonil, tolylfluanid, and flusulfamid;
(vi) an inorganic active compound selected from the group consisting of Bordeaux composition, copper acetate, copper hydroxide, copper oxychloride, basic copper sulfate, and sulfur; and
(vii) an other compound selected from the group consisting of ametoctradin, spiroxamine, cymoxanil, cyflufenamid, valiphenal, metrafenone, fosetly-aluminium, and dithianon.

19. The method according to claim 18, wherein compound (A) is pyraclostrobin and compound (B) is metiram.

20. The method of claim 16, wherein the free amino acids stored in the plant are selected from the group consisting of arginine, asparagine, glutamine, aspartic acid, threonine, serine, glutamic acid, alanine, proline, glycine, valine, isoleucine, leucine, tyrosine, phenylalanine, lysine, and histidine.

21. The method of claim 16, wherein the free amino acids are stored in the plant are selected from the group consisting of arginine, asparagine, and glutamine.

22. The method of claim 16, wherein the perennial plant is selected from the group consisting of agricultural, silvicultural, and horticultural plants, each in its natural or genetically modified form.

23. The method of claim 22, wherein the perennial plant is selected from the group consisting of trees, herbaceous plants, shrubs, and bulbous plants.

24. The method of claim 22, wherein the plant is selected from the group consisting of asparagus, grapevine, pomes, bananas, apples, pears, plums, peaches, almonds, cherries, strawberries, raspberries, currant, blackberries, gooseberries, oranges, lemons, grapefruits, mandarins, nut trees, oil palm, tobacco, coffee, tea, hop, and turf.

25. The method of claim 22, wherein the plant is grapevine.

26. The method of claim 16, wherein the storage tissue is selected from the group consisting of bark, wood, root, tubers, bulbs, pseudobulb, caudex, taproot, corm, storage hypocotyl, and rhizomes.

27. The method of claim 16, wherein the applying step is carried out following the period of reproductive growth.

28. The method of claim 16, wherein the applying step is carried out at least twice.

29. A method for increasing the level of free amino acids in storage tissues of a perennial plant, comprising applying an agrochemical mixture of at least one strobilurin compound (A) selected from the group consisting of pyraclostrobin, orysastrobin, azoxystrobin, dimoxystrobin, enestroburin, fluoxastrobin, kresoxim-methyl, metominostrobin, orysastrobin, picoxystrobin, pyribencarb, trifloxystrobin, 2-(2-(6-(3-chloro-2-methyl-phenoxy)-5-fluoro-pyrimidin-4-yloxy)-phenyl)-2-methoxyimino-N-methyl-acetamide, 3-15 methoxy-2-(2-(N-(4-methoxy-phenyl)-cyclopropane-carboximidoylsulfanylmethyl)-phenyl)-acrylic acid methyl ester, methyl (2-chloro-5-[1-(3-methylbenzyloxyimino)-ethyl]benzyl)carbamate, and 2-(2-(3-(2,6-dichlorophenyl)-1-methyl-allylideneaminooxymethyl)-phenyl)-2-methoxyimino-N-methyl-acetamide; and
at least one further active ingredient compound (B) selected from the group consisting of
(i) a carboxylic amide selected from the group consisting of fluopyram, boscalid, fenhexamid, metalaxyl, di-methomorph, fluopicolide (picobenzamid), zoxamide, mandipropamid, carpropamid,
N-(3′,4′,5′-trifluorobiphenyl-2-yl)-3-difluoromethyl-1-methyl-1H-pyrazole-4-carboxamide, N-[2-(4′-trifluoromethylthio)-biphenyl]-3-difluoromethyl-1-methyl-1H-pyrazole-4-carboxamide, bixafen, N-[2-(1,3-dimethylbutyl)-phenyl]-1,3-dimethyl-5-fluoro-1H-pyrazole-4-carboxamide, sedaxane, isopyrazam, and penthiopyrad;
(ii) an azole selected from the group consisting of cyproconazole, difenoconazole, epoxiconazole, flusi-lazole, fluquinconazole, flutriafol, ipconazole, metconazole, propiconazole, prothioconazole, tebuconazole, cyazofamid, prochloraz, ethaboxam, and tri-azoxide;
(iii) a heterocyclic compound selected from the group consisting of famoxadone, fluazinam, cyprodinil, pyrimethanil, fenpropimorph, iprodione, acibenzolar-S-methyl, proquinazid, quinoxyfen, fenpiclonil, captan, fenpropidin, captafol, and anilazin;
(iv) a carbamate or dithiocarbamate compound selected from the group consisting of mancozeb, metiram, iprovalicarb, maneb, propineb, flubenthiavalicarb (benthiavalicarb), and propamocarb;
(v) an organo-chloro compound selected from thiophanate methyl, chlorothalonil, tolylfluanid, and flusulfamid;
(vi) an inorganic active compound selected from the group consisting of Bordeaux composition, copper acetate, copper hydroxide, copper oxychloride, basic copper sulfate, and sulfur; and
(vii) an other active compound selected from the group consisting of ametoctradin, spiroxamine, cymoxanil, cyflufenamid, valiphenal, metrafenone, fosetly-aluminium, and dithianon.

30. The method of claim 29, wherein the at least one strobilurin compound (A) is selected from the group consisting of pyraclostrobin, azoxystrobin, kresoxim-methyl, trifloxystrobin, and picoxystrobin.

31. The method of claim 29, wherein the agrochemical mixture comprises pyraclostrobin as compound (A) and metiram as compound (B).

32. The method of claim 29, wherein the free amino acids stored in the plant are selected from the group consisting of arginine, asparagine, glutamine, aspartic acid, threonine, serine, glutamic acid, alanine, proline, glycine, valine, isoleucine, leucine, tyrosine, phenylalanine, lysine, and histidine.

33. The method of claim 29, wherein the free amino acids are stored in the plant are selected from the group consisting of arginine, asparagine, and glutamine.

34. The method of claim 29, wherein the perennial plant is selected from the group consisting of agricultural, silvicultural, and horticultural plants, each in its natural or genetically modified form.

35. The method of claim 34, wherein the perennial plant is selected from the group consisting of trees, herbaceous plants, shrubs, and bulbous plants.

36. The method of claim 34, wherein the plant is selected from the group consisting of asparagus, grapevine, pomes, bananas, apples, pears, plums, peaches, almonds, cherries, strawberries, raspberries, currant, blackberries, gooseberries, oranges, lemons, grapefruits, mandarins, nut trees, oil palm, tobacco, coffee, tea, hop, and turf.

37. The method according to claim 34, wherein the plant is grapevine.

38. The method of claim 29, wherein the storage tissue is selected from the group consisting of bark, wood, root, tubers, bulbs, pseudobulb, caudex, taproot, corm, storage hypocotyl, and rhizomes.

39. The method of claim 29, wherein the applying step is carried out following the period of reproductive growth.

40. The method of claim 29, wherein the applying step is carried out at least twice.
